(19) United States
(12) Patent Application Publication
(10) Pub. No.: US 2026/0291081 A1
(43) Pub. Date: Sep. 24, 2026

(54) BASE STATION ANTENNAS HAVING LIGHTWEIGHT HYBRID CYLINDRICAL METAMATERIAL LENS ANTENNA

(71) Applicant: Outdoor Wireless Networks LLC, Richardson, TX (US)

(72) Inventors: Jimmy Ho, Hickory, NC (US); Nicolas Uribe, Denver, NC (US); George Steven Zema, Hickory, NC (US); Lance Darren Bamford, Pittsford, NY (US)

(21) Appl. No.: 19/569,382

(22) Filed: Mar. 17, 2026

Related U.S. Application Data
(60) Provisional application No. 63/774,288, filed on Mar. 19, 2025.
(60) Provisional application No. 63/895,566, filed on Oct. 8, 2025.

(51) Int. Cl. H01Q 19/06; H01Q 1/24

(52) U.S. Cl. CPC H01Q 19/06; H01Q 1/246

(57) ABSTRACT

Base station antennas include a cylindrical RF lens and at least one radiating element. The cylindrical RF lenses are hybrid lenses that include both metamaterial focusing elements and dielectric material focusing elements. The RF lenses may comprise a plurality of concentric cylindrical laminae having conductive scattering elements formed thereon and thin dielectric slabs to enhance the performance of the sparsely spaced scattering elements to achieve well defined patterns with low sidelobes and low cross polar discrimination.

### CROSS-REFERENCE TO RELATED APPLICATION

The present application claims priority under 35 U.S.C. § 119 to U.S. Provisional Application Ser. No. 63/774,288, filed Mar. 19, 2025, and U.S. Provisional Application Ser. No. 63/895,566, filed Oct. 8, 2025, the entire contents of both are incorporated herein by reference as if set forth in their entirety.

### FIELD

The present invention relates to base station antennas for cellular communications systems and, more particularly, to base station antennas having cylindrical metamaterial radio frequency (“RF”) lenses.

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. In many cases, the cell may be divided into a plurality of “sectors” in the azimuth plane (a horizontal plane that bisects the antenna that is parallel to the plane defined by the horizon), and separate base station antennas provide coverage to each of the sectors. The base station antennas are often mounted on a tower or other raised structure, with the radiation patterns (“antenna beams”) that are generated by the antennas directed outwardly to provide service to the respective sectors. Reference will also be made herein to the elevation plane, which refers to a plane that is perpendicular to the azimuth plane that bisects the front surface of the base station antenna.

A common base station configuration is a “three sector” configuration in which a cell is divided into three 120° sectors in the azimuth plane, and the base station includes three base station antennas that provide coverage to the three respective sectors. Typically, each base station antenna will include one or more phase-controlled arrays of dual-polarized radiating elements. A dual-polarized radiating element is a radiating element that includes a first radiator that transmits and receives RF energy at a first polarization and a second radiator that transmits and receives RF energy at a second polarization that is orthogonal to the first polarization. For passive (non-active beamforming) applications, each array typically comprises a vertically-extending column of radiating elements that is referred to as a “linear array” of radiating elements, although it will be appreciated that in some cases one or more of the radiating elements in a linear array may be offset from the remainder of the radiating elements in the horizontal direction to narrow the azimuth beamwidth of the antenna beams generated by the linear array, and in some cases a linear array may comprise a single radiating element. Each linear array of radiating elements is coupled to a pair of ports of a radio through respective first and second polarization feed networks. RF signals input at the first radio port are split into a plurality of sub-components by the first polarization feed network and fed to the first polarization radiators of the radiating elements in the linear array. The first polarization radiators radiate the sub-components of the RF signal into free space, generating a first antenna beam. Similarly, RF signals received from the second radio port are split into a plurality of sub-components by the second polarization feed network and fed to the second polarization radiators of the radiating elements in the linear array, thereby generating a second antenna beam. The phases of the sub-components of the RF signals that are fed to the different radiating elements in a linear array may be set (e.g., by the length of the RF transmission lines in the feed networks) so that the RF energy radiated by the different radiating elements constructively combine to narrow the beamwidth of the antenna beam in the column direction. Narrower antenna beams concentrate the RF energy into a smaller area, thereby increasing the gain of the antenna beam.

The shape of each antenna beam generated by a linear array of radiating elements is defined by, among other things, the characteristics of the individual radiating elements, the characteristics of the array (e.g., whether the array is a single radiating element or a column of radiating elements, the spacing between adjacent radiating elements in the linear array, and any horizontal stagger in the column) and by the magnitudes and phases of the sub-components of the RF signal that are fed to each individual radiating element in the linear array. Antenna beams are often characterized by their Half Power Beam Width (“HPBW”). The HPBW refers to the number of degrees, in a designated plane such as the azimuth or elevation planes, where the radiated power of a main lobe of the antenna beam is within 3 dB (50%) of the peak power of the antenna beam. Typically, the radiating elements used in base station antennas are configured to generate an “element” radiation pattern (i.e., the antenna beam formed by a single radiating element) that has a HPBW in both the azimuth and elevation planes of about 65°, which ensures that the antenna beam generated by each radiating element provides good coverage throughout a 120° sector in the azimuth plane. If a linear array comprises multiple radiating elements, the sub-components of the RF signal that are fed to the different radiating elements in the column may be phased so that the radiation patterns generated by each subset of one or more radiating elements constructively combine to produce a composite antenna beam having a narrowed HPBW (e.g., 5°-25°) in the elevation (vertical) plane.

As capacity requirements have grown, cellular network operators are now dividing some cells into more than three sectors. For example, cells may now be divided into six, nine, twelve, fifteen or eighteen sectors in the azimuth plane. Typically, multibeam “sector-splitting” antennas are used when cells are divided into more than three sectors. A multibeam sector-splitting antenna refers to a base station antenna that generates multiple antenna beams (per polarization) that have narrowed beamwidths in the azimuth plane (i.e., azimuth HPBWs of less than about 60°, and typically less than about 35°) , where the pointing directions of the multiple antenna beams (per polarization) are designed to split a sector into a plurality of sub-sectors. This allows a single base station antenna to generate the multiple antenna beams (per polarization) that provide coverage to the respective sub-sectors of a 120° sector.

For example, a six-sector base station will divide each 120° sector in the azimuth plane into two 60° sub-sectors. Such a six-sector base station will typically be served by three base station antennas that are each implemented as a “twin-beam” antenna that is designed to generate first and second antenna beams (per polarization) that provide coverage to the respective first and second 60° sub-sectors of each 120° sector. Each antenna beam may have a HPBW in the azimuth plane of about 30-35°. The first antenna beam may point at an angle of about −27° to −30° in the azimuth plane from the boresight pointing direction of the antenna and the second antenna beam may point at an angle of about 27° to 30° in the azimuth plane from the boresight pointing direction of the antenna. The boresight pointing direction of the antenna is the center, in the azimuth plane, of the 120° sector served by the antenna. In this fashion, the 120° sector is split into two 60° sub-sectors that are covered by the respective first and second antenna beams.

Providing cellular service in large venues such as stadiums, arenas, convention centers, concert halls and the like may be particularly challenging, as very larger numbers of users may be located in a very small area. In such venues, multibeam sector-splitting base station antennas that generate three or more antenna beams per polarization may be used, where each antenna beam provides coverage to a respective 20°-40° (or smaller) sub-sector in the azimuth plane. When a 120° sector is sub-divided into sub-sectors, the system capacity can be increased significantly because the RF energy of each antenna beam is focused into a smaller area and therefore provides a higher antenna gain.

There are two common approaches used to implement a multibeam antenna. In the first approach, a multi-column antenna array is provided that is coupled to a beamforming network such as a Butler Matrix based beamforming network. Multiple RF signals (per polarization) are input to the beamforming network, which sub-divides the signals and feeds the signals to the multi-column array. The beamforming network may be configured to generate a separate antenna beam for each RF signal that is input thereto, and also electronically steers the generated antenna beams so that they point in different directions. Such an antenna may be designed to generate an antenna beam (per polarization) for each sub-sector of a sector served by the antenna, with the antenna beams pointed toward the respective sub-sectors.

The second approach used to implement a multibeam antenna is to include a plurality of linear arrays in an antenna that are arranged behind one or more RF lenses. The RF lenses are used to narrow the beamwidths of the antenna beams generated by the base station antenna, thereby increasing the gain of the antenna beams. The RF lenses may, for example, be planar, cylindrical or spherical RF lenses. Each linear array is positioned so that its generated antenna beams will impinge on one or more RF lenses, with each antenna beam directed toward a respective sub-sector. The RF lens(es) concentrate the RF radiation into a more focused (i.e., narrower) antenna beams in at least the azimuth plane so that each antenna beam will have an appropriate size to provide service to a respective sub-sector of the sector served by the base station antenna. RF lenses conventionally have been formed using dielectric materials such as polyethylene, and often used a combination of dielectric materials having different relative permittivities to achieve a desired focusing effect. Unfortunately, the size, weight and/or cost of such dielectric lenses is often prohibitive if substantial narrowing of the antenna beams is required. The use of metamaterial RF lenses has also been suggested. Metamaterials, which are also called artificial dielectric materials, refer to a class of materials that have properties that are not usually found in naturally occurring materials, such as a negative refractive index. Metamaterial RF lenses typically comprise a plurality of conductive elements that are small in terms of the wavelengths of the RF energy that is to be focused (e.g., the largest dimension of each conductive element is less than half the smallest a wavelength of the RF energy that is to be focused, and often less than one-tenth of the smallest wavelength). For example, U.S. Patent Publication No. 2024/0347922 (“the '922 publication”) discloses various metamaterial RF lenses that are suitable for use in base station antennas

FIG. 1 is a side perspective view of an antenna that includes a cylindrical Luneburg lens that is formed using graded dielectric materials with a higher relative permittivity close to the axis of the cylindrical lens, reducing in radial steps to a lower relative permittivity close to the circumference of the cylinder, as disclosed in European U.S. Pat. No. 3,401,999. Such solutions are heavy and expensive, especially in the sub-6 GHz frequency range where narrow beam antennas require a cylindrical lens with a large physical diameter.

FIG. 2 is a side perspective view of a cylindrical RF lens that is a step approximation of a Luneburg lens as disclosed in U.S. Patent Publication No. 2019/0393614. The cylindrical RF lens shown in FIG. 2 comprises concentric rings of low-density dielectric foam that is loaded with varying quantities of high dielectric constant material, thus providing a lens in the form of an assembly of concentric cylinders having graded relative permittivity.

### SUMMARY

Pursuant to some embodiments of the present invention, antennas are provided that comprise a cylindrical RF lens and a radiating element that is arranged to illuminate the cylindrical RF lens. The cylindrical RF lens comprises a plurality of substantially planar dielectric plates, each dielectric plate extending in a respective radial direction and having a first edge proximate an axis of the cylindrical RF lens wherein the angles between the radial directions are equal, and a plurality of concentric cylindrical dielectric shells, wherein each dielectric shell supports a plurality of conductive scattering elements, the conductive scattering elements being arranged in rows and columns, the rows and columns being aligned to extend at angles of 45° and −45° relative to the axis of the cylindrical RF lens.

In some embodiments, the cylindrical RF lens includes more dielectric plates than cylindrical dielectric shells. In some embodiments, a dielectric constant of at least one of the dielectric plates exceeds a dielectric constant of at least one of the cylindrical dielectric shells. In some embodiments, a thickness of at least one of the dielectric plates exceeds a thickness of at least one of the cylindrical dielectric shells. In some embodiments, the dielectric plates are devoid of conductive scattering elements.

In some embodiments, each of the dielectric plates includes a plurality of slots that extend parallel to the axis of the cylindrical RF lens. In such embodiments, the cylindrical dielectric shells may be received within the slots in the dielectric plates.

In some embodiments, an average spacing between adjacent conductive scattering elements is at least 0.2 wavelengths corresponding to a center frequency of the operating frequency band of the radiating element.

In some embodiments, the radiating element is a first radiating element, and the antenna further comprises a second radiating element. In such embodiments, the first and second radiating elements may be stacked along an axis that extends in parallel with the axis of the cylindrical RF lens, or may be spaced apart from each other in a plane that is perpendicular to the axis of the cylindrical RF lens.

Pursuant to further embodiments of the present invention, base station antennas are provided that comprise a radiating element and a cylindrical RF lens that comprises a plurality of concentric cylindrical dielectric shells, wherein each dielectric shell supports a plurality of conductive scattering elements, the conductive scattering elements being arranged in rows and columns, the rows and columns being aligned to extend at angles of 45° and −45° relative to an axis of the cylindrical RF lens.

In some embodiments, the cylindrical RF lens further comprises a plurality of dielectric plates, each dielectric plate extending in a respective radial direction and having a first edge proximate an axis of the cylindrical RF lens. In some embodiments, the angles between the radial directions are equal.

In some embodiments, the cylindrical RF lens includes more dielectric plates than cylindrical dielectric shells. In some embodiments, a dielectric constant of at least one of the dielectric plates exceeds a dielectric constant of at least one of the cylindrical dielectric shells. In some embodiments, a thickness of at least one of the dielectric plates exceeds a thickness of at least one of the cylindrical dielectric shells. In some embodiments, the dielectric plates are devoid of conductive scattering elements.

In some embodiments, each of the dielectric plates includes a plurality of slots that extend parallel to the axis of the cylindrical RF lens. In such embodiments, cylindrical dielectric shells are received within the slots in the dielectric plates.

In some embodiments, an average spacing between adjacent conductive scattering elements is at least 0.2 wavelengths corresponding to a center frequency of the operating frequency band of the radiating element.

Pursuant to additional embodiments of the present invention, base station antennas are provided that comprise a radiating element and a cylindrical RF lens. The cylindrical RF lens comprises a cylindrical support element and a plurality of planar dielectric plates that extend radially outwardly from the cylindrical support element.

In some embodiments, the cylindrical support element comprises a plurality of slots that extend in parallel to an axis of the cylindrical RF lens. In some embodiments, each planar dielectric plate is received within a respective one of the slots.

In some embodiments, the cylindrical RF lens further comprises a plurality of concentric cylindrical dielectric shells, wherein each dielectric shell supports a plurality of conductive scattering elements. In some embodiments, the conductive scattering elements are arranged in rows and columns, the rows and columns being aligned to extend at angles of 45° and −45° relative to an axis of the cylindrical RF lens.

In some embodiments, the cylindrical RF lens includes more dielectric plates than cylindrical dielectric shells. In some embodiments, a dielectric constant of at least one of the dielectric plates exceeds a dielectric constant of at least one of the cylindrical dielectric shells. In some embodiments, the dielectric plates are devoid of conductive scattering elements. In some embodiments, a thickness of at least one of the dielectric plates exceeds a thickness of at least one of the cylindrical dielectric shells.

Pursuant to other embodiments of the present invention, base station antennas are provided that comprise a cylindrical RF lens that comprises a set of first laminae, each first laminae extending radially outward from an axis and a radiating element that is configured to radiate toward the cylindrical RF lens. Each first laminae comprises a planar dielectric substrate and a plurality of conductive scattering elements on at least one major surface of the planar dielectric substrate.

In some embodiments, the cylindrical RF lens further comprises a set of second laminae, each second laminae intersecting at least two of the first laminae. In some embodiments, each second laminae extends in a respective plane that is parallel to planes defined by major surfaces of each first laminae.

In some embodiments, a first number of first laminae in the set of first laminae exceeds a second number of second laminae in the set of second laminae. In some embodiments, a thickness of at least one of the second laminae exceeds a thickness of at least one of the first laminae. In some embodiments, a thickness of at least one of the second laminae exceeds thicknesses of every one of the first laminae.

In some embodiments, each first laminae comprises a planar dielectric substrate and a plurality of conductive scattering elements on at least one major surface of the planar dielectric substrate, and each second laminae comprises a dielectric substrate which optionally may have one or more conductive scattering elements on at least one major surface thereof, and wherein a density of conductive scattering elements on at least one of the first laminae exceeds a density of conductive scattering elements on at least one of the second laminae. In some embodiments, respective densities of conductive scattering elements on each of the first laminae exceed a density of conductive scattering elements on at least one of the second laminae.

In some embodiments, each first laminae comprises a planar dielectric substrate and a plurality of conductive scattering elements on at least one major surface of the planar dielectric substrate, and at least one of the second laminae is devoid of conductive scattering elements.

In some embodiments, the first laminae are rectangular laminae.

In some embodiments, the cylindrical RF lens further comprising a cylindrical support element, wherein an edge of each first laminae is received within a respective one of the slots in the cylindrical support element.

Pursuant to still further embodiments of the present invention, base station antennas are provided that comprise a cylindrical RF lens that comprises a set of first laminae, each first laminae extending in a respective one of a plurality of vertical planes and a set of second laminae, each second laminae extending in a respective one of a plurality of horizontal planes; and a radiating element that is configured to radiate toward the RF lens. Each first laminae comprises a planar dielectric substrate and a plurality of conductive scattering elements on at least one major surface of the planar dielectric substrate.

In some embodiments, a first number of first laminae in the set of first laminae exceeds a second number of second laminae in the set of second laminae. In some embodiments, a thickness of at least one of the second laminae exceeds a thickness of at least one of the first laminae. In some embodiments, a density of conductive scattering elements on at least one of the first laminae exceeds a density of conductive scattering elements on at least one of the second laminae. In some embodiments, at least one of the second laminae is devoid of conductive scattering elements.

Pursuant to yet additional embodiments of the present invention, base station antennas are provided that comprise a cylindrical RF lens that has a central axis and a radiating element that is configured to radiate toward the RF lens. The cylindrical RF lens comprises a set of first laminae, each first laminae extending radially outward from the central axis and a set of second laminae, each second laminae perpendicular to the central axis. A first number of first laminae in the set of first laminae exceeds a second number of second laminae in the set of second laminae.

In some embodiments, the first number is at least three times the second number. In some embodiments, a thickness of at least one of the second laminae exceeds a thickness of at least one of the first laminae. In some embodiments, each of the first laminae comprises a planar dielectric substrate and a plurality of conductive scattering elements on at least one major surface of the planar dielectric substrate. In some embodiments, a density of conductive scattering elements on at least one of the first laminae exceeds a density of conductive scattering elements on at least one of the second laminae.

Pursuant to still other embodiments of the present invention, base station antennas are provided that comprise a cylindrical RF lens and a radiating element that is configured to radiate toward the RF lens. The cylindrical RF lens comprises a set of first laminae, each first laminae extending in a respective one of a plurality of vertical planes and a set of second laminae, each second laminae extending in a respective one of a plurality of horizontal planes. Each first laminae comprises a planar dielectric substrate and a plurality of conductive scattering elements on at least one major surface of the planar dielectric substrate and each second laminae comprises a dielectric substrate, and a density of conductive scattering elements on at least one of the first laminae exceeds a density of conductive scattering elements on at least one of the second laminae.

In some embodiments, a first number of first laminae in the set of first laminae exceeds a second number of second laminae in the set of second laminae. In some embodiments, thickness of at least one of the second laminae exceeds a thickness of at least one of the first laminae. In some embodiments, the density of conductive scattering elements on the at least one of the first laminae exceeds a density of conductive scattering elements on all of the second laminae. In some embodiments, at least one of the second laminae is devoid of conductive scattering elements.

### BRIEF DESCRIPTION OF THE DRAWINGS

FIG. 1 is a schematic perspective view of a conventional antenna that includes a step approximation of a cylindrical RF Luneburg lens that is formed using conventional dielectric materials.

FIG. 2 is a schematic perspective view of a conventional cylindrical RF Luneburg lens that is formed using artificial dielectric materials.

FIG. 3A is a schematic perspective view of a base station antenna comprising a radiating element, a reflector and an RF lens that comprises a plurality of planar dielectric plates arranged radially about a common longitudinal axis.

FIG. 3B is a graph of the simulated radiation patterns generated by the base station antenna of FIG. 3A when the radiating element is placed at 2 different locations behind the RF lens.

FIG. 4A is a schematic perspective view of a base station antenna according to embodiments of the present invention that comprises a radiating element, a reflector and a cylindrical RF lens formed by a plurality of concentric cylindrical dielectric shells that have conductive scattering elements thereon.

FIG. 4B is a graph of the simulated co-polarization and cross-polarization responses generated by the base station antenna of FIG. 4A.

FIG. 5A is a schematic view of the relative orientations of rows and columns of conductive scattering elements on one of the dielectric shells, the planes of polarization, and the axis of the cylindrical RF lens of the base station antenna of FIG. 4A.

FIG. 5B is a graph of the simulated co-polar and cross-polar radiation patterns generated by the base station antenna of FIG. 4A when the conductive scattering elements spaced relatively far apart from each other.

FIG. 6 is a schematic exploded perspective view of another lensed base station antenna according to embodiments of the present invention.

FIG. 7 is a schematic perspective view of the base station antenna of FIG. 6 when fully assembled.

FIG. 8 is a schematic perspective view a base station antenna that comprises two of the base station antennas of FIG. 7 that are attached to each other.

FIG. 9 is a schematic perspective view a base station antenna according to further embodiments of the present invention arranged in a case.

FIG. 10 is a schematic perspective view of the base station antenna of FIG. 9 with a weather-protective radome added.

FIG. 11 is graph showing the measured azimuth radiation pattern of the base station antenna of FIG. 10.

FIG. 12 is graph showing the measured elevation radiation pattern of the base station antenna of FIG. 8.

FIG. 13A is a cross-sectional view of a base station antenna according to embodiments of the present invention that includes three linear arrays of radiating elements located at differing azimuth angles relative to an axis of a cylindrical RF lens that is part of the base station antenna.

FIGS. 13B-13D are computed wavefronts as the radiated signals from each of the linear arrays of radiating elements propagates through the cylindrical RF lens shown in FIG. 13A.

FIG. 14 is a graph of the measured radiation patterns in the MVG Nearfield Chamber provided by each of the three independent antenna beams formed by signals radiated from the base station antenna of FIG. 13A.

FIG. 15 is a schematic perspective view of the cylindrical RF lens of FIG. 7 that further shows the volume consumed by the components of the cylindrical RF lens.

FIGS. 16A-16D are a front view, a top view, a side view and a perspective view, respectively, of a base station antenna according to further embodiments of the present invention that includes a hybrid cylindrical RF lens.

FIG. 17 is a graph of the azimuth radiation pattern of the base station antenna of FIGS. 16A-16D.

FIG. 18 is a top view of a dual-beam base station antenna according to embodiments of the present invention that includes the same cylindrical RF lens of the antenna of FIGS. 16A-16D.

FIGS. 19A and 19B are schematic perspective views of dual frequency band base station antennas according to further embodiments of the present invention that include cylindrical RF lenses.

FIG. 20 is a side perspective view of the internal components of a base station antenna according to further embodiments of the present invention.

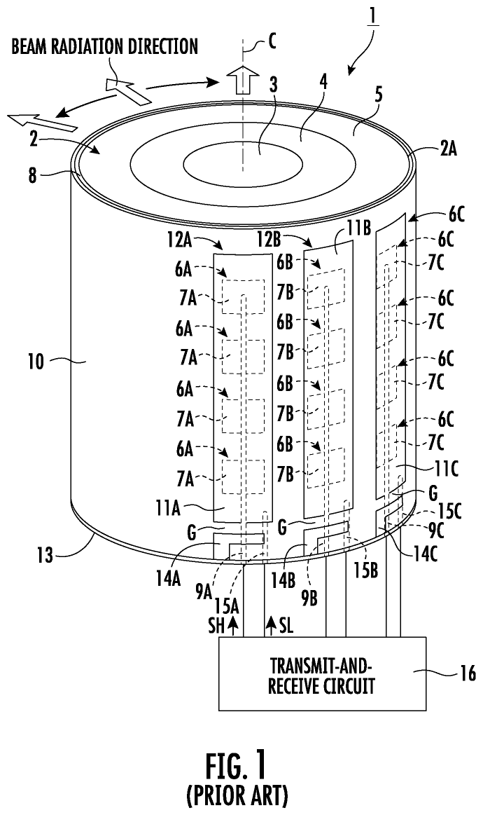

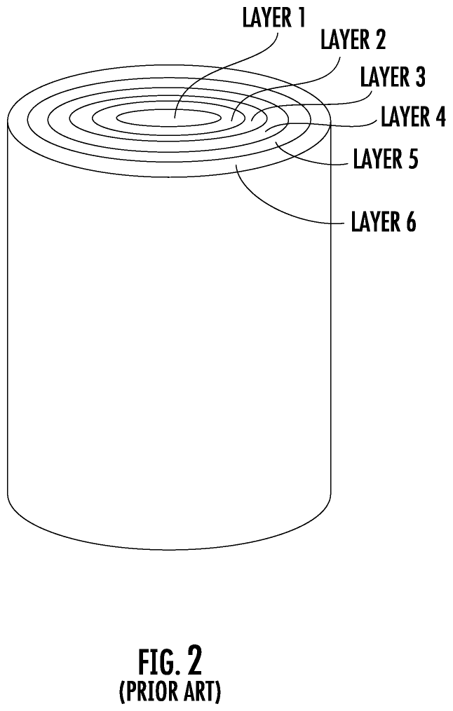

### DETAILED DESCRIPTION

Pursuant to embodiments of the present invention, base station antennas are provided that include cylindrical metamaterial RF lenses that are lightweight and simple to manufacture and that exhibit good radiation patterns and cross-polarization performance. The base station antennas according to some embodiments of the present invention include cylindrical lenses that each comprise a plurality of concentric cylindrical dielectric shells, where at least some of the dielectric shells support a plurality of conductive scattering elements that may, for example, be arranged in rows and columns. In some embodiments, the conductive scattering elements may extend along axes that lie at 45° angles with respect to longitudinal axis of the cylindrical RF lens. These cylindrical RF lenses may also include a plurality dielectric slabs that may be devoid of conductive scattering elements (or which have fewer conductive scattering elements) that further focus RF radiation that is incident on the cylindrical RF lens. In some embodiments, the dielectric slabs may comprise support pieces that facilitate holding sections of the concentric cylindrical dielectric shells in place, while also acting as lens elements that further focus the incident RF radiation.

Pursuant to further embodiments of the present invention, base station antennas are provided that include cylindrical RF lenses that include a set of first laminae that extend radially outward from a vertical axis and a set of second laminae that extend in respective horizontal planes. Each first laminae may comprise, for example, a dielectric substrate that has a plurality of conductive scattering elements thereon. Each second laminae may comprise, for example, a dielectric substrate that has fewer or no conductive scattering elements thereon. The first laminae may be arranged to define a cylinder. The conductive scattering elements on the first laminae may focus incident RF radiation, but may be somewhat sparsely populated on the first laminae to ensure the cross-polarization discrimination performance is acceptable. The second laminae may perform additional focusing of incident RF radiation to achieve a desired amount of focusing within a given cylinder volume.

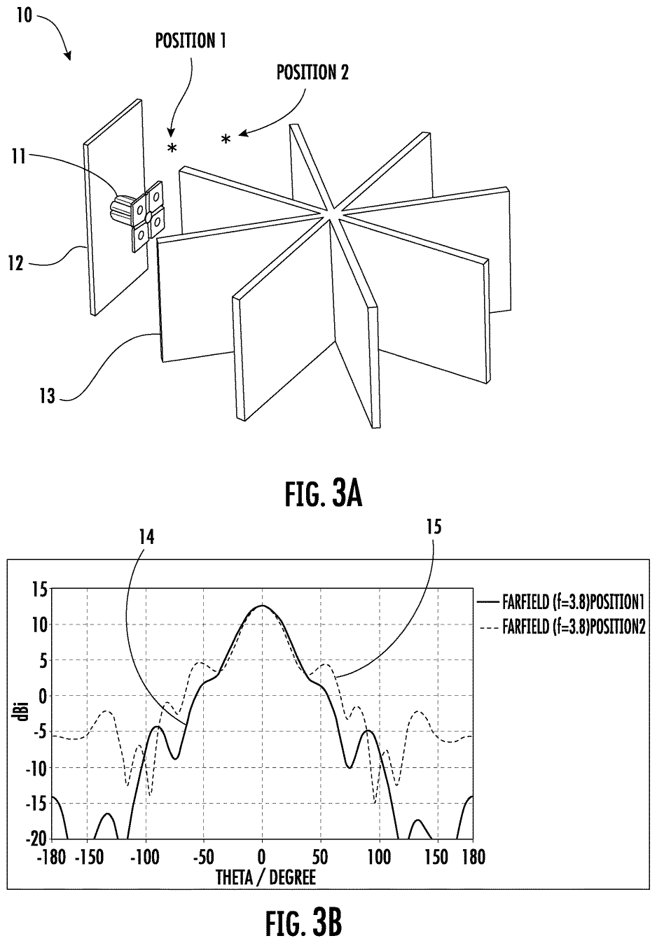

Base station antennas according to embodiments of the present invention will now be described with reference to FIGS. 3A-20. It will be appreciated that the antennas disclosed herein have reciprocal properties, whether transmitting or receiving a signal. In the following description, any property or mode of operation described by way of explanation when transmitting a signal has the same or cognate property or mode when receiving a signal.

FIG. 3A is a schematic perspective view of a base station antenna 10 that comprises a radiating element 11, a reflector in the form of conductive lamina 12, whose function is to direct energy towards the axis of an RF lens that comprises a plurality of substantially planar dielectric members 13, hereafter referred to as dielectric plates 13, that are arranged radially about a common longitudinal axis. Each of the dielectric plates 13 is characterized by an axial height, a radial width, a thickness and a relative permittivity. In the example shown the radiating element 11 is in the form of a crossed dipole radiating element and the reflector 12 is a substantially planar metal reflector that may be formed from, for example, sheet metal. It will be understood that the dielectric plates 13 provide some degree of focusing of the RF energy passing therethrough in a radial direction, and hence operate as a lens. The arrangement of dielectric plates 13, however, is only symmetrical when viewed from certain directions, namely when aligned with a radial plate and when aligned with the bisector of the angle between adjacent radial plates.

It is found that the effectiveness of the arrangement of dielectric plates 13 in focusing energy depends on the polarization of the energy radiated by the radiating element 11 as well as the choice of the dimensions of the dielectric plates 13 and the material from which they are made.

FIG. 3B is a graph of the radiation patterns generated by the base station antenna 10 of FIG. 3A when the radiating element 11 is positioned at two different locations around the contour of dielectric members 13. When the radiating element 11 is positioned at Position 1, radiation pattern 14 is generated. When the radiating element 11 is positioned at Position 2, radiation pattern 15 is generated. As discussed above, sector-splitting antennas that employ RF lenses to narrow the antenna beams deploy a plurality of linear arrays of radiating elements behind the RF lens(es), where each linear array has one or more radiating elements. Ideally, the radiation patterns generated by each linear array (after passing through the RF lens) will be the same no matter where the linear arrays are is positioned behind the RF lens so that the antenna beams serving each sub-sector will exhibit the same performance. FIG. 3B shows that the cylindrical RF lens formed by the dielectric plates 13 is effective in narrowing the antenna beams generated by radiating element 11. However, for at least some radiating element positions (corresponding to curve 15), the side lobe levels are very high (less than 8 dB below the peak of the main lobe), which is not acceptable in cellular applications. As such, the base station antenna 10 of FIG. 3A may not be appropriate for use in most cellular networks, but it does demonstrate the focusing capability of the dielectric members 13 since a narrow beam radiation pattern can be achieved.

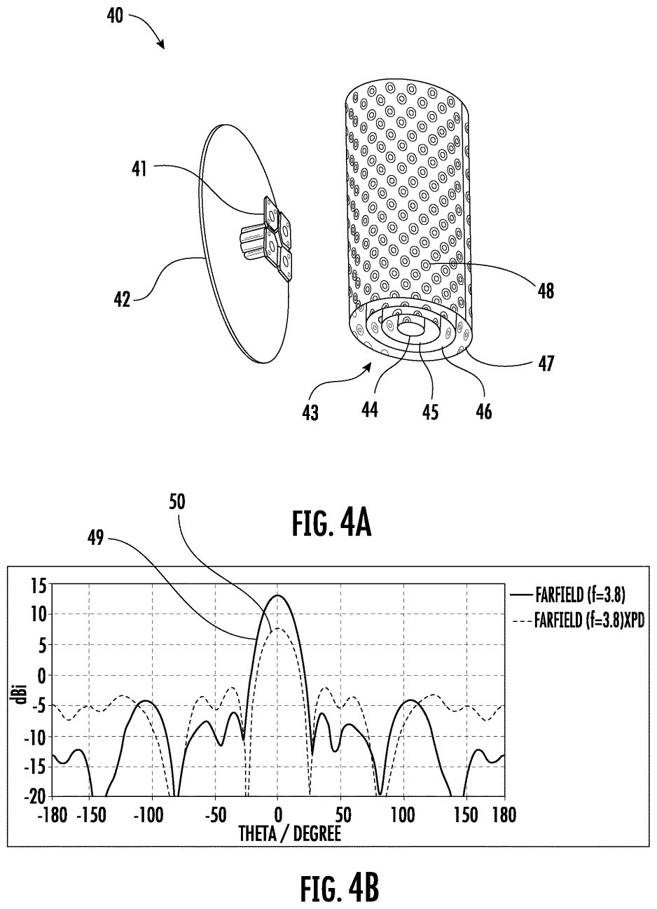

FIG. 4A is a schematic perspective view of a base station antenna 40 that comprises a radiating element 41, a reflector 42 and a cylindrical RF lens 43. The reflector 42 is oriented to reflect RF energy that is emitted backwardly by radiating element 41 towards the cylindrical RF lens 43. The cylindrical RF lens 43 comprises a plurality of concentric cylindrical dielectric shells 44, 45, 46, 47, where each shell has an arrangement of conductive scattering elements 48 thereon. In some embodiments, the concentric cylindrical dielectric shells 44, 45, 46, 47 having conductive scattering elements 48 thereon may be implemented using flexible printed circuit boards.

In some embodiments the scattering elements 48 may be annular in shape, but many other shapes are possible. The conductive scattering elements 48 may be in the form of concentric circles or concentric squares as described in U.S. patent application Ser. No. 18/298,795, but the present invention is not limited to the use of those shapes. The conductive scattering elements included in the cylindrical RF lenses may have dimensions that are small compared with the wavelength at the operating frequency of the base station antenna. For example, the dimensions of each scattering element 48 may be on the order of 0.05 wavelengths.

FIG. 4B is a graph illustrating the typical co-polarization (curve 49) and cross-polarization (curve 50) responses of base station antenna 40 when the scattering elements 48 are spaced closely together. The co-polarization pattern 49 has a very good shape, but the cross-polarization pattern 50 has a peak value that is only about 5 dB below the peak co-polarization value, meaning that almost one third of the RF power emitted at a first polarization is converted to the second (orthogonal) polarization. Cellular network operators typically expect peak cross-polarization values to be much lower, such as at least 15 dB or even 20 dB below the peak co-polarization value. Thus, base station antenna 40 also is generally not suitable for use in a mobile communications network.

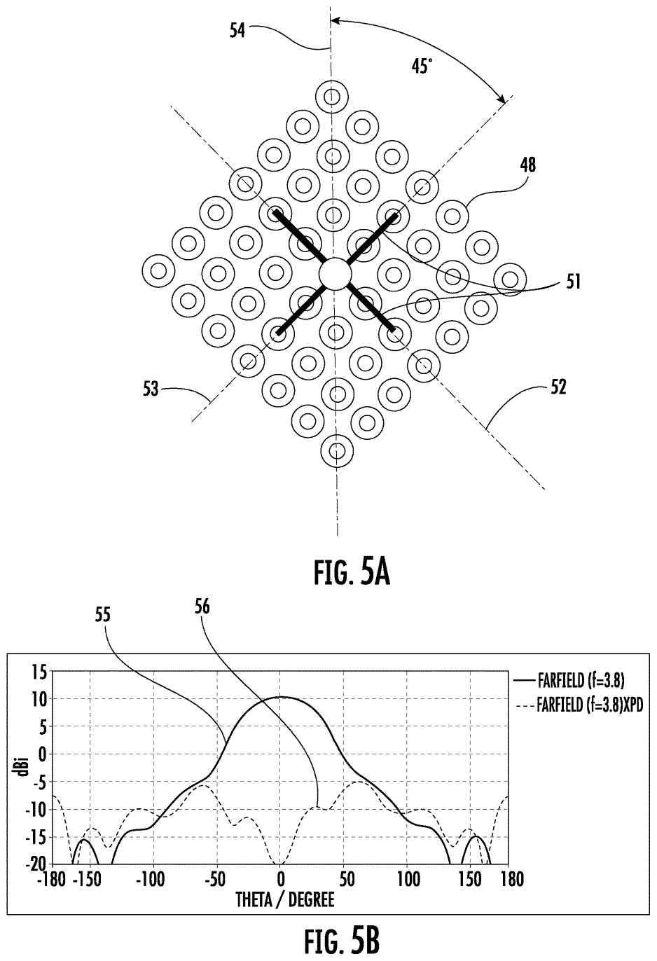

In embodiments where the radiating element 41 is configured to radiate signals having dual orthogonal linear polarizations, for example having polarization directions of +45° and −45° relative to the axis of the cylindrical RF lens, the scattering elements 48 are preferably arranged such that the spacing of rows and columns of scattering elements 48 are equal, and that the rows and columns are aligned with the directions of polarization, as shown in FIG. 5A. A typical spacing between rows and between columns is 0.25 wavelengths. Note that herein references to the “axis” of a cylindrical RF lens refer to the axis that extends through the centers of the two parallel circular bases of the cylinder defined by the cylindrical RF lens.

FIG. 5A is a schematic view of an example of a small part of one of the dielectric shells 44, 45, 46, 47 of the cylindrical RF lens of FIG. 4 on which the conductive scattering elements 48 are formed. The orthogonal planes of polarization 52, 53 of the dual-polarized radiating element 51 having dipole radiators oriented at ±45° relative to the axis of the lens 54 are shown by dotted-dashed lines in FIG. 5A. The conductive scattering elements 48 are arranged in rows and columns, which preferably may be aligned with the polarization planes 52, 53, as shown. In FIG. 5A, a small part of one of the dielectric shells is shown after being spread into a flat sheet of material; in a practical embodiment, as seen in FIG. 4A, the dielectric shells 44, 45, 46, 47 are formed into concentric cylindrical dielectric shells that have a common axis 54.

The arrangement of FIG. 5A may also be preferred for use with an illuminating linear array of one or more radiating elements having circular polarization. When the cylindrical RF lens 43 of FIG. 4A is used in conjunction with one or more linear arrays of radiating elements having radiators that transmit and receive RF signals at vertical and/or horizontal polarizations, the columns of conductive scattering elements 48 may preferably be aligned with the longitudinal axis of the lens 43 so that the columns of conductive scattering elements 48 extend along the axis of the cylindrical RF lens 43.

The spacing between adjacent conductive scattering elements 48 may impact both the co-polarization patterns and the cross-polarization discrimination performance of the antenna beams generated by base station antenna 40 of FIG. 4A. When the conductive scattering elements 48 are spaced relatively far apart, such as by a distance of approximately 0.25 wavelengths of the center frequency of the operating frequency band of the radiating element 41 or greater, the cross-polarization discrimination improves to 30 dB, but the radiation patterns are broad (i.e., the 3 dB and 10 dB beamwidths are larger than desired) due to poor beam convergence because the number of conductive scattering elements 48 is reduced.

While FIG. 5A illustrates the conductive scattering elements 48 being positioned the same distance apart in the row and column directions, it will be appreciated that embodiments of the present invention are not limited thereto. In fact, in some applications it may be preferrable to have adjacent conductive scattering elements 48 be very close to each other along the +/−45° polarization axes while being farther apart along the vertical axis. For example, adjacent conductive scattering elements 48 might be spaced apart by 14 mm along the 45° diagonal whole being spaced apart by 20 mm along the vertical axis, which is a ratio 0.7. It will also be appreciated that FIG. 5A illustrates a relatively dense population of conductive scattering elements 48, and that the conductive scattering elements 48 may be spaced farther apart than shown in FIG. 5A in other embodiments.

FIG. 5B is a graph of the simulated co-polarization radiation pattern 55 and the cross-polarization radiation pattern 56 for the base station antenna 40 of FIG. 4A when the conductive scattering elements 48 are spaced apart from each other by a distance of approximately 0.25 wavelengths of the center frequency of the operating frequency band of the radiating element 41. The simulated results shown in FIG. 5B are based on a cylindrical RF lens 43 that has the same sized aperture as the cylindrical RF lens 43 used in the simulations that were used to generate the graphs of FIG. 3B and FIG. 4B. As can be seen by comparing FIGS. 4B and 5B, the co-polarization pattern 55 has a much wider beamwidth than co-polarization pattern 49, which results because of the sparse density of conductive scattering elements 48. However, the cross-polarization pattern 56 (in the boresight pointing direction) has improved significantly to 30 dB as compared to the cross-polarization pattern 50 in FIG. 4B, which exhibits cross-polarization discrimination of only about 5 dB.

The arrangement of FIG. 3A only works well for radiating elements positioned at specific positions behind the RF lens formed by the dielectric plates 13. The arrangement of FIG. 4A exhibits poor co-polarization radiation patterns when the density of conductive scattering elements 48 is high, and exhibits insufficient focusing when the density of conductive scattering elements 48 is low. Thus, individually, the structures of FIGS. 3A and 4A may not be effective. However, a high level of performance where the sidelobes are low, gain is high and cross polarization is low, may be obtained by using a novel combination of the RF lens of FIG. 3A and the RF lens of FIG. 4A where the conductive scattering elements 48 are spaced apart by larger distances.

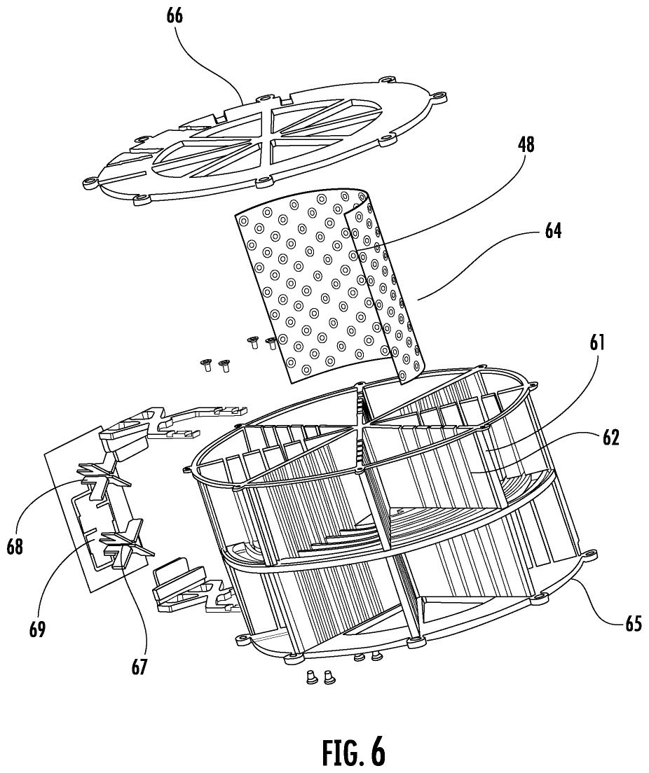

FIG. 6 is a schematic exploded perspective view of a base station antenna according to embodiments of the present invention. The base station antenna includes a linear array of radiating elements that includes two radiating elements 67, 68 and a cylindrical RF lens that comprises a radial assembly 61 of dielectric plates, a plurality of substantially circular dielectric members 65, 66, and a plurality of concentric dielectric substrates 64 that have conductive scattering elements 48 formed thereon. The dielectric plates that comprise the radial assembly 61 are provided with a plurality of longitudinal grooves or ridges 62. The dielectric substrates 64 are received within the grooves 62 in the radial assembly 61. Each dielectric substrate 64 is dimensioned in width such that when curved and assembled into the radial assembly 61 it conforms with a desired arcuate cross sectional profile so that the dielectric substrates 64 are arranged as a plurality of concentric dielectric substrates in the manner shown in FIG. 4A.

In the exemplary embodiment of the present invention shown in FIG. 6, the radial assembly 61 includes eight radially-extending dielectric plates, each dielectric plate being arranged to support the flexible substrates that form five dielectric shells 64. The dielectric plates included in the radial assembly 61 may have a relativel high dielectric constant in some embodiments to enhance focusing of the RF energy. In some embodiments, the dielectric plates may have a dielectric constant of between 2.0 and 10.0 or between 2.5 and 10.0, or between 3.0 and 10.0. The dielectric plates may also be made to be thicker than the dielectric substrates 64 in order to enhance focusing of the RF radiation. In this embodiment the complete assembly will comprise a set of five dielectric shells 64, each dielectric shell 64 having the same axial length, and a width arranged according to the diameter of each of the concentric cylinders. The set of dielectric shells 64 is retained by the substantially circular dielectric members 65, 66 which are attached by screws or other means to radial assembly 61.

The electrical properties of the cylindrical RF lens of FIG. 6 is provided by the action of the radial assembly 61 of dielectric plates combined with the action of the concentric cylindrical dielectric shells 64 with the conductive scattering elements 48 formed thereon.

Cylindrical RF lenses are designed to focus incident RF radiation in the plane orthogonal to the axis of the cylindrical RF lens. Thus, if a cylindrical RF lens is mounted so that the axis of the cylinder extends vertically, the cylindrical RF lens will focus incident RF radiation in the azimuth plane. Conventional cylindrical RF lenses do not focus RF energy in radial planes that are parallel to the axis of the cylinder, and hence a cylindrical RF lens that is mounted so that the axis of the cylinder extends vertically will not focus incident RF radiation in the elevation plane. As shown in FIG. 6, in order to focus energy in the elevation plane, the cylindrical lens is illuminated by a linear array of two (or more) radiating elements 67, 68, where the radiating elements 67, 68 are arranged in a column that extends in parallel with the axis of the cylinder. As discussed above, the sub-components of an RF signal that are fed to the individual radiating elements may be phased so that the individual antenna beams generated by the two radiating elements constructively combine to form a composite antenna beam that has a narrowed beamwidth in the elevation plane. In this manner, the RF radiation may be focused in both the radial and axial planes, which correspond to the azimuth and elevation planes, respectively, if the cylindrical RF lens is mounted vertically. The example shown in FIG. 6 is provided with an array of two radiating elements 67, 68, fed from a common feed point 69.

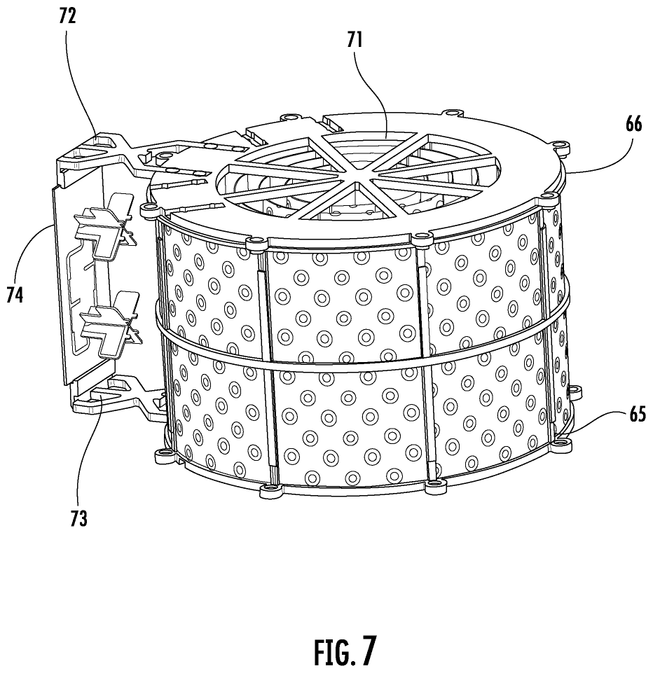

FIG. 7 is a schematic perspective view of the base station antenna of FIG. 6 after assembly. The circular dielectric members 65, 66 include apertures 71 to reduce the weight thereof and also to facilitate inspection of the assembled antenna. Brackets 72, 73 provide for the attachment of the feed arrangement 74 to dielectric members 65, 66.

Referring to FIGS. 5A, 6 and 7, pursuant to certain embodiments of the present invention, antennas are provided that comprise a cylindrical RF lens and a radiating element 67, 68 that is arranged to illuminate the cylindrical RF lens. The cylindrical RF lens comprises an assembly 61 that includes a plurality of substantially planar dielectric plates, each dielectric plate extending in a respective radial direction and having a first edge proximate an axis of the cylindrical RF lens where the angles between the radial directions are equal, and a plurality of concentric cylindrical dielectric shells 64, wherein each dielectric shell 64 supports a plurality of conductive scattering elements 48, the conductive scattering elements 48 being arranged in rows and columns, the rows and columns being aligned to extend at angles of 45° and −45° relative to the axis of the cylindrical RF lens.

In some embodiments, the cylindrical RF lens includes more dielectric plates than cylindrical dielectric shells 64. In some embodiments, a dielectric constant of at least one of the dielectric plates exceeds a dielectric constant of at least one of the cylindrical dielectric shells 64. In some embodiments, a thickness of at least one of the dielectric plates exceeds a thickness of at least one of the cylindrical dielectric shells 64. In some embodiments, the dielectric plates are devoid of conductive scattering elements 48.

In some embodiments, each of the dielectric plates includes a plurality of slots 62 that extend parallel to the axis of the cylindrical RF lens. In such embodiments, the cylindrical dielectric shells 64 may be received within the slots 62 in the dielectric plates.

In some embodiments, an average spacing between adjacent conductive scattering elements 48 is at least 0.2 wavelengths or at least 0.25 wavelengths, where the “wavelength” is the wavelength corresponding to a center frequency of the operating frequency band of the radiating element 67, 68.

Referring to FIGS. 6 and 7, pursuant to additional embodiments of the present invention, base station antennas are provided that comprise a radiating element and a cylindrical RF lens that comprises a plurality of concentric cylindrical dielectric shells, wherein each dielectric shell supports a plurality of conductive scattering elements, the conductive scattering elements being arranged in rows and columns, the rows and columns being aligned to extend at angles of 45° and −45° relative to an axis of the cylindrical RF lens.

Still referring to FIGS. 6 and 7, pursuant to additional embodiments of the present invention, base station antennas are provided that comprise a radiating element and a cylindrical RF lens. The cylindrical RF lens comprises a cylindrical support element and a plurality of planar dielectric plates that extend radially outwardly from the cylindrical support element. In some embodiments, the cylindrical support element comprises a plurality of slots that extend in parallel to an axis of the cylindrical RF lens. In some embodiments, each planar dielectric plate is received within a respective one of the slots.

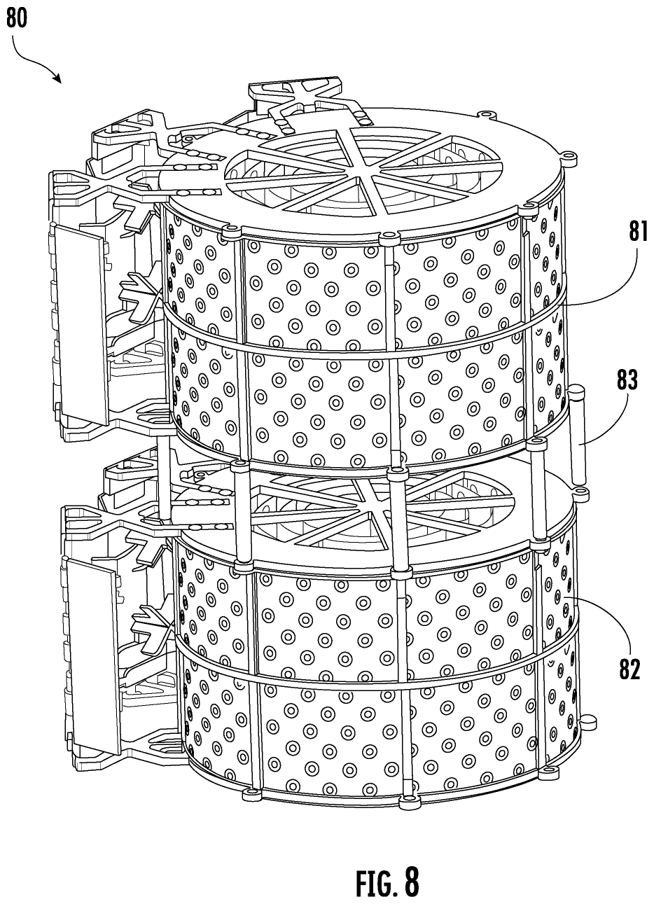

FIG. 8 is a schematic perspective view of an assembly 80 comprising two base station antennas 81, 82 that are connected together by support members 83. Each base station antenna 81, 82 may have the configuration shown in FIGS. 6 and 7. In some embodiments, base station antennas 81 and 82 may be similar in dimensions and may operate in the same frequency band, while in other embodiments they may be of different configurations and operate in different frequency bands. If base station antennas 81 and 82 operate in different frequency bands then they will typically be different sizes.

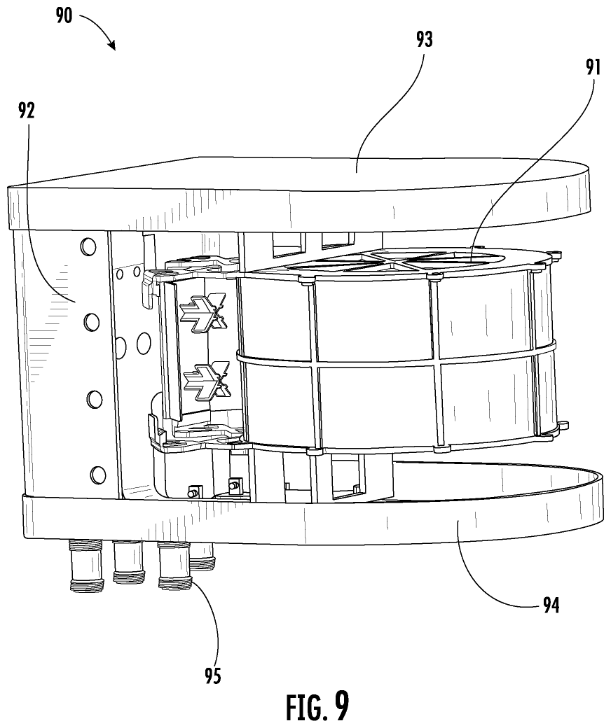

FIG. 9 is a schematic perspective view of a base station antenna 90 that includes a cylindrical RF lens 91 according to further embodiments of the present invention. Base station antenna 90 may correspond to the base station antenna of FIG. 7 with additional elements added. As shown in FIG. 9, base station antenna 90 adds ends members 93, 94 and support member 92 together with a plurality of RF connectors 95 to the base station antenna of FIG. 7. The RF connectors 95 are mounted in the lower end member 94 to feed RF signals to the linear arrays of radiating elements included in base station antenna. The base station antenna 90 may be configured to operate as a 2xMIMO (multi-input-multi-output) antenna, but can be configured to operate as a 4xMIMO antenna if two of the antennas stacked vertically or arranged side-by-side. In other embodiments, a second linear array could be added behind the cylindrical RF lens 91 that is spaced apart from the first linear array in the azimuth plane and the base station antenna 90 could operate as a sector-splitting antenna that divides a coverage area into two sub-sectors in the azimuth plane that are covered by the antenna beams generated by the two respective linear arrays.

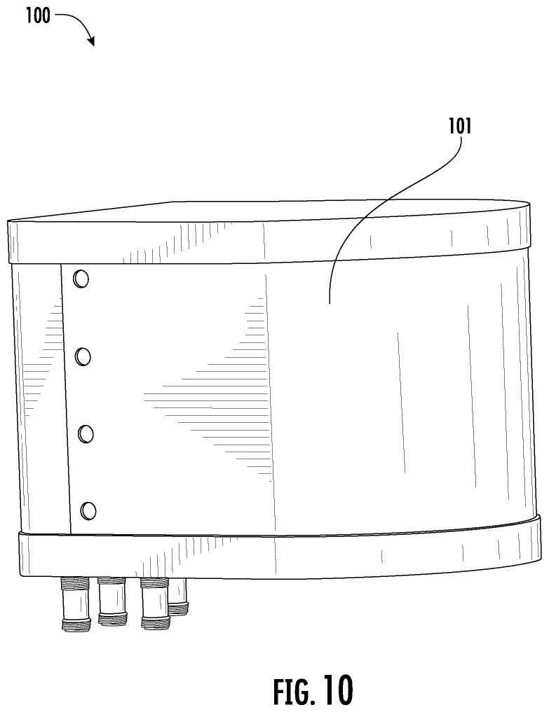

FIG. 10 is a schematic perspective view of a complete base station antenna 100 configured according to an embodiment of the present invention. Base station antenna 100 corresponds to base station antenna 90 with a weatherproof dielectric cover (radome) 101 added to protect the components of the base station antenna 100 from environmental factors such as wind and rain.

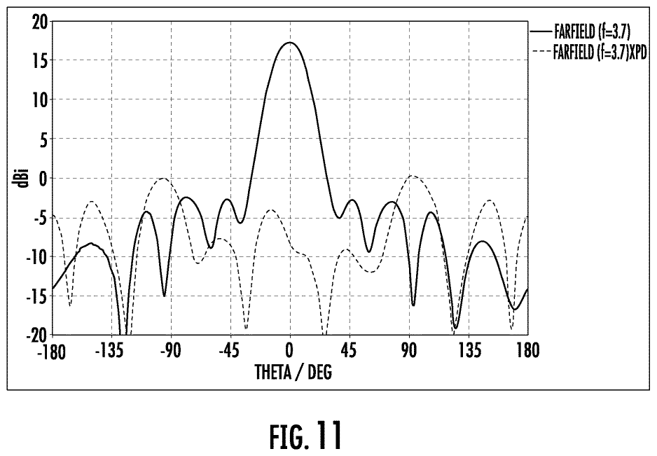

FIG. 11 is a graph of the simulated azimuth pattern a base station antenna that is similar to the base station antenna 100 of FIG. 10, except that the antenna used to generate the azimuth pattern of FIG. 11 included a single radiating element. The diameter of the cylindrical RF lens used in the simulation was 200 mm, and the lens was oriented with its axis extending vertically. As shown in FIG. 11, the generated antenna beam has a measured azimuth beamwidth of 23.1° at 3.7 GHz, with a measured directivity of 17.2 dB and a maximum sidelobe level in the azimuth plane of −20 dB, together with cross-polar discrimination of 26 dB on the axis of the beam (i.e., in the boresight pointing direction).

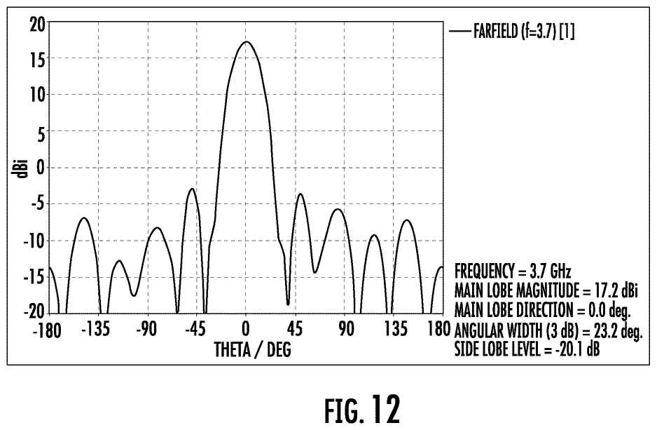

FIG. 12 is a graph of the measured elevation radiation pattern of the base station antenna according to FIG. 7, which includes a linear array that has two radiating elements. As shown in FIG. 12, this base station antenna, when fed with 3.7 GHz RF signals, has a 3-dB beamwidth of 23.2°, a directivity of 17.2 dB and a sidelobe level that is 20.1 dB below peak gain.

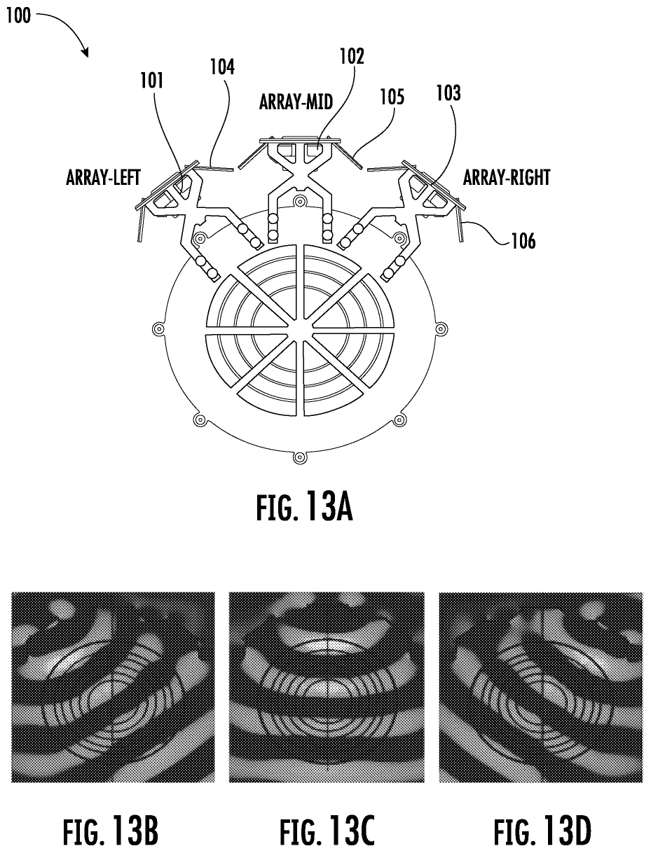

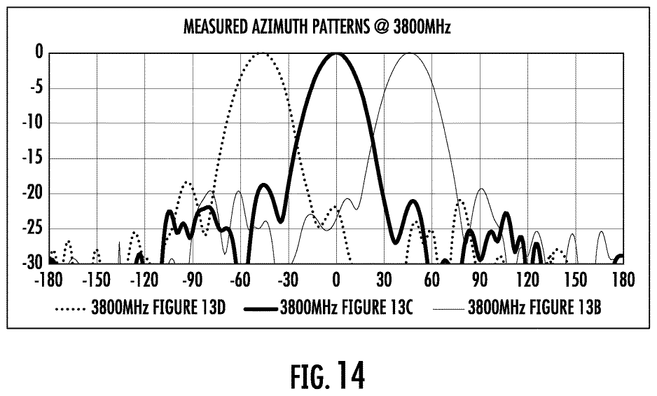

FIG. 13A is a schematic top view of a base station antenna 100 that includes three linear arrays of radiating elements 101, 102, 103 that are arranged at differing azimuth angles relative to the axis of a vertically-oriented cylindrical RF lens. Each linear array 101, 102, 103 may include one or more radiating elements that are arranged in respective vertically-extending columns. FIGS. 13B, 13C and 13D show simulated wavefronts as the RF signals radiated by each linear array of radiating elements 101, 102, 103 propagate through the cylindrical RF lens. It can be seen that the curved wavefront emitted by the linear arrays becomes straightened as the wave propagates through the cylindrical RF lens.

In a preferred embodiment the reflectors 104, 105, 106 behind each linear array of radiating elements 101, 102, 103 are non-planar, where the shapes of the reflectors 104, 105, 106 are arranged to reduce coupling between adjacent linear arrays 101, 102, 103.

It will be understood that the base station antenna of FIG. 13A will operate as a sector-splitting antenna that divides a coverage area of the antenna into a plurality (here three) sectors in the azimuth plane, with the antenna generating a separate pair of antenna beams (since dual-polarized radiating elements are used) to provide service to each sub-sector of the coverage area.

FIG. 14 is a graph illustrating the MVG Nearfield measured azimuth radiation patterns of the three independent antenna beams generated by the three linear arrays of the base station antenna shown in FIG. 13A. In this example the 3 dB azimuth beamwidth of each beam is approximately 22°, all sidelobes are at least 19 dB below the main beams and the main beams are separated by an azimuth angle of approximately 45°.

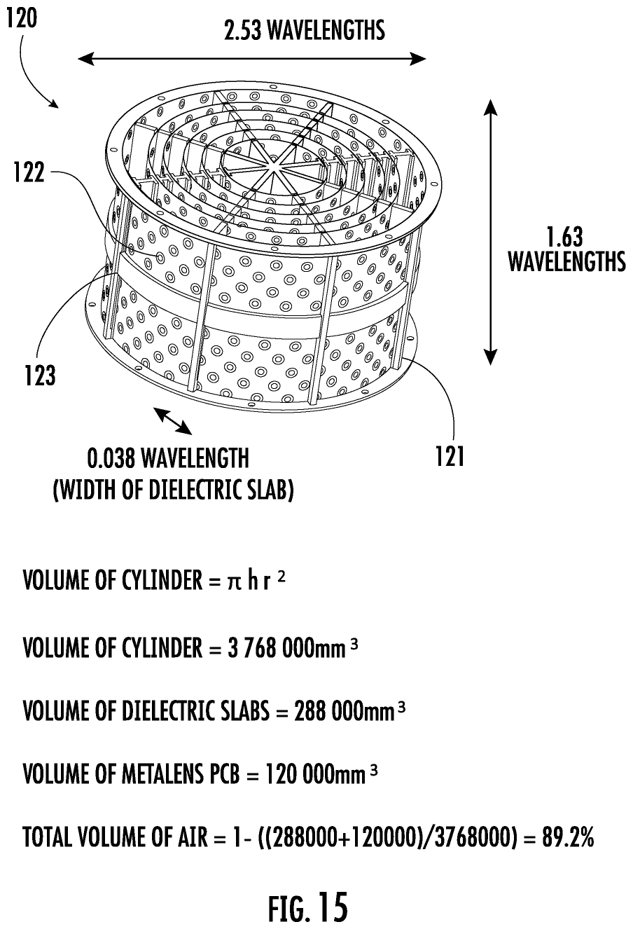

FIG. 15 is a schematic perspective view of the cylindrical RF lens included in the base station antenna of FIG. 7, and FIG. 15 further includes calculations of the volumes consumed by the dielectric members 121 of the radial assembly and by the flexible dielectric substrates 122 as compared to the total volume of the cylinder 123 defined by the cylindrical RF lens. These calculations show that the cylindrical RF lens 120 included in the base station antenna of FIG. 7 is approximately 89% empty space or air which translates into a very light weight lens.

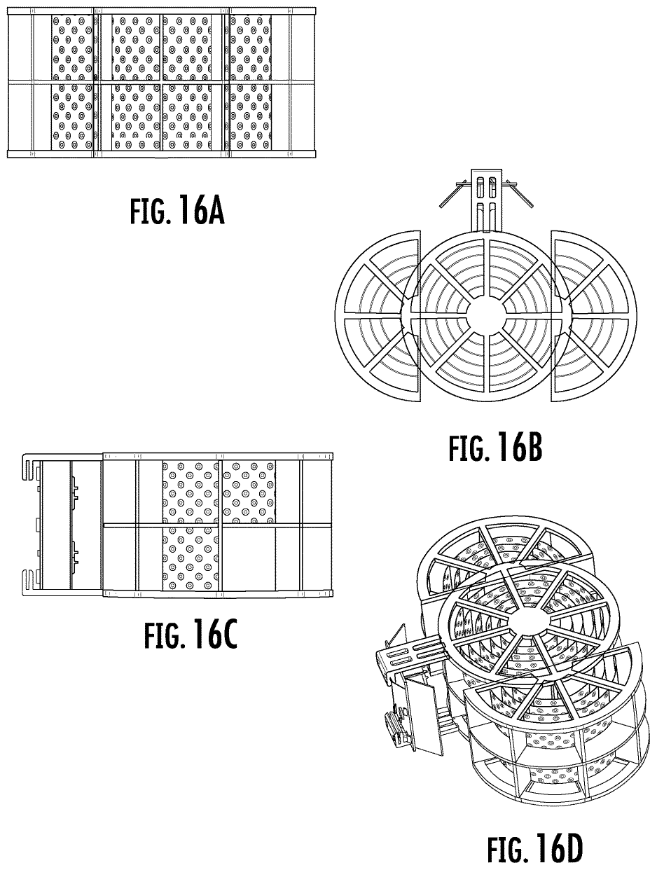

FIGS. 16A-16D are a front view, a top view, a side view and a perspective view, respectively, of a base station antenna according to further embodiments of the present invention that includes a hybrid cylindrical RF lens. As shown, the hybrid cylindrical RF lens comprises a first cylindrical RF lens and second and third semi-cylindrical RF lenses that are mounted on opposed sides of the first cylindrical RF lens. The cylindrical RF lens may be any of the cylindrical RF lenses discussed above, and the semi-cylindrical RF lenses may be one half of any of the cylindrical RF lenses discussed above.

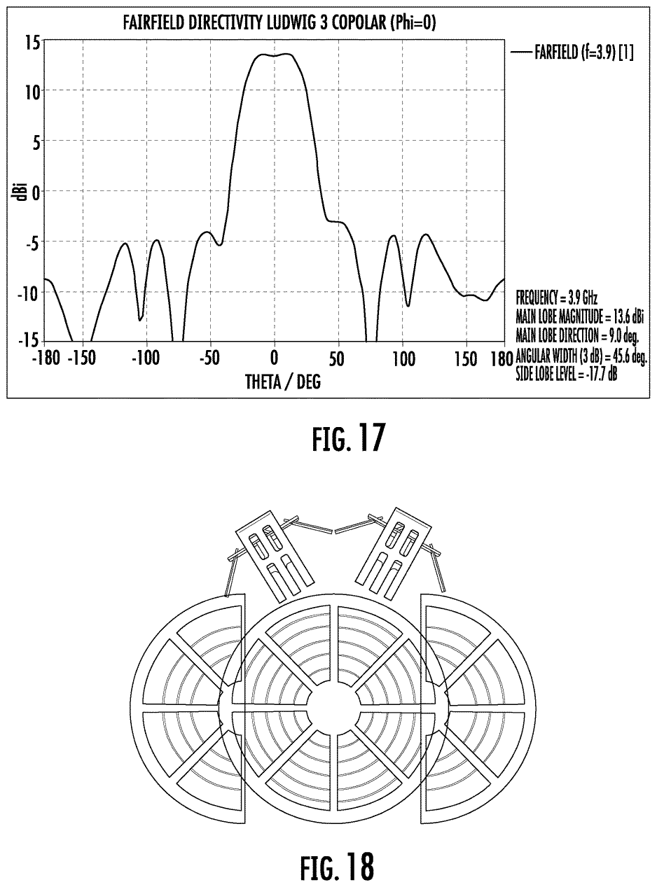

FIG. 17 is a graph of the azimuth pattern of the base station antenna of FIGS. 16A-16D. As shown in FIG. 17, the generated antenna beam has a “square” beam shape in the azimuth plane.

FIG. 18 is a top view of a dual-beam (i.e., sector-splitting) base station antenna according to embodiments of the present invention that includes the same hybrid cylindrical RF lens as the base station antenna of FIGS. 16A-16D. As shown in FIG. 18, first and second linear arrays of radiating elements (only the top radiating element in each linear array is visible in FIG. 18) are mounted to illuminate the RF lens structure. Each linear array is angled to point toward a desired coverage area. The base station antenna of FIG. 18 may, for example, be used to form two antenna beams (per polarization) that cover respective sub-sectors of a sector of a cell of a cellular communications network.

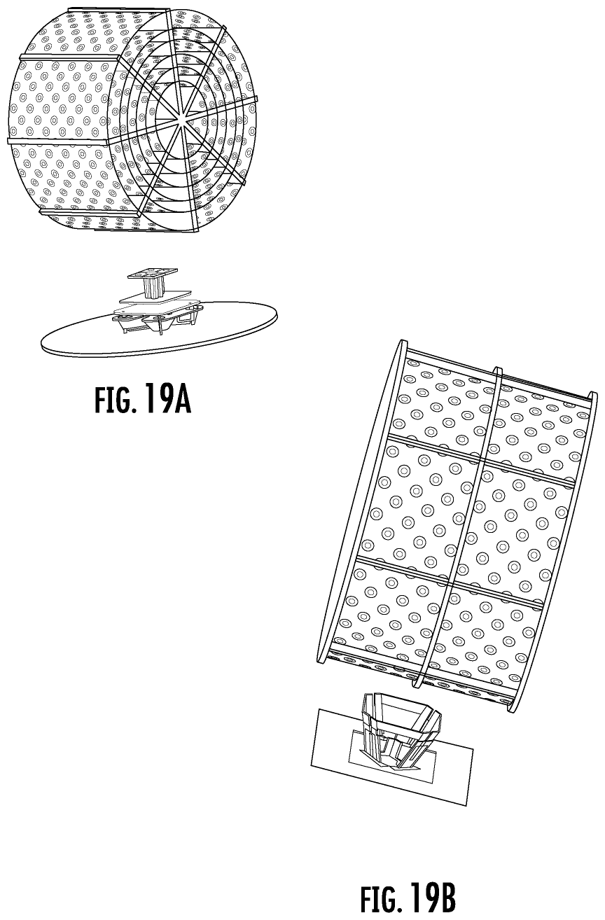

FIGS. 19A and 19B are schematic perspective views of dual-band antennas according to embodiments of the present invention that include cylindrical RF lenses. As shown in FIGS. 19A-19B, radiating elements that operate in two different frequency bands may be mounted on a reflector and positioned so that the RF energy that they radiate will pass through the cylindrical RF lens, which may be any of the above-described cylindrical RF lenses according to embodiments of the present invention. In the embodiment of FIG. 19A, the two radiating elements are stacked above the reflector plate. In the embodiment of FIG. 19B, a higher frequency band cross-dipole radiating element is mounted in the center of a lower frequency band box dipole radiating element.

The cylindrical RF lenses discussed above with respect to FIGS. 6-19B are hybrid cylindrical RF lenses in that they employ both standard dielectric materials (e.g., the radial assembly 61 in FIG. 6) as well as metamaterial structures (e.g., the dielectric substrates 64 that have conductive scattering elements 48 formed thereon) to focus the RF radiation that is incident on the cylindrical RF lens. The additional focusing provided by the standard dielectric materials allows the density of conductive scattering elements 48 included on the concentric cylindrical dielectric sheets to be reduced while still providing sufficient focusing, which improves the cross-polarization discrimination performance of the antennas.

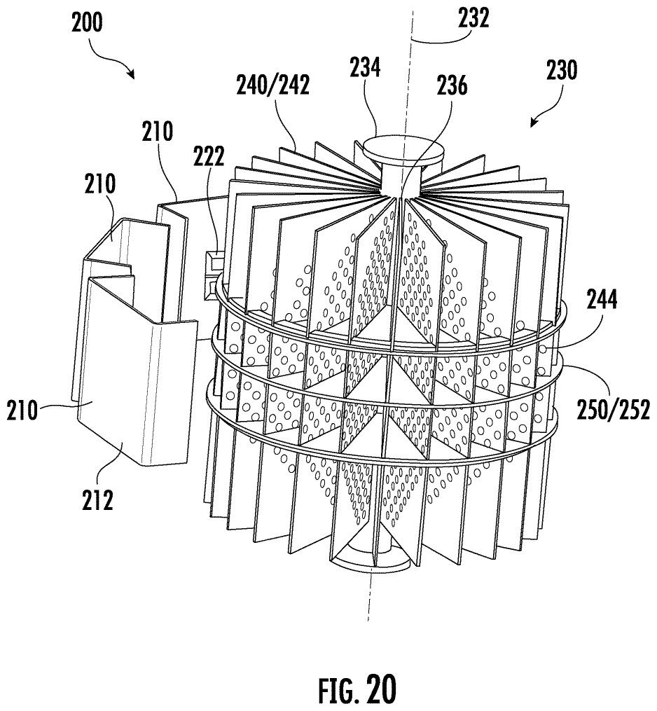

FIG. 20 is a side perspective view of the internal components of a base station antenna 200 according to further embodiments of the present invention. Base station antenna 200 includes three reflectors 210, three linear arrays 220 of radiating elements 222 (only one of the linear arrays is visible in FIG. 20) and a cylindrical RF lens 230. A support frame (not shown) may also be provided that mounts the linear arrays 220 of radiating elements 222 to the cylindrical RF lens 230. As shown, each reflector 210 comprises a planar sheet of metal 212, and the radiating elements 222 are mounted to extend forwardly from the respective planar metal sheets 212. Edges of each planar metal sheet 212 are bent forwardly to help narrow the radiation patterns emitted by the individual radiating elements 222 and to increase isolation between adjacent radiating elements 222.

The radiating elements 222 may comprise, for example, slant −/+45° cross-dipole radiating elements. Moreover, while each linear array 210 is shown as including a single radiating element 222, it will be appreciated that in other embodiments the linear arrays 210 may each include two or more radiating elements 222 to reduce the beamwidth of the generated antenna beams in the elevation plane.

The cylindrical RF lens 230 differs from the above-described cylindrical RF lenses according to embodiments of the present invention in that cylindrical RF lens 230 includes a set of first laminae 240 that have conductive scattering elements 244 formed thereon and a set of second laminae 250. Each first laminae 240 extends radially outward from an axis 232 of the cylinder defined by cylindrical RF lens 230. Each first laminae 240 comprises a planar rectangular dielectric substrate 242 that has a plurality of conductive scattering elements 244 on at least one major surface of the planar rectangular dielectric substrate 242. The conductive scattering elements 244 may be arranged on the dielectric substrate 242 in rows and columns that extend along the polarization planes of the RF radiation emitted by the dipole radiators of the radiating elements 222, and hence the conductive scattering elements 244 may be positioned as shown in FIG. 5A above. Cylindrical RF lens 230 further comprises a cylindrical support member 234 that has a plurality of longitudinal slots 236 formed therein. Inner ends of each first laminae 240 may be received within a respective one of the slots 236.

Cylindrical RF lens 230 further includes the set of second laminae 250. Each second laminae 250 extends in a respective plane that is perpendicular to planes defined by the major surfaces of the first laminae 240. Each second laminae 250 may intersect at least two of the first laminae 230. In some embodiments, each second laminae 250 may have a planar semi-circular shape and may intersect about half of the first laminae 240. Each second laminae 250 may comprise a planar dielectric substrate 252 that has a plurality of slots formed therein that cooperate with corresponding slots in the dielectric substrates 242 of the first laminae 240 so that the first and second laminae 240, 250 may be interconnected in the fashion shown in FIG. 20.

In some embodiments, at least one, and as many as all, of the second laminae 250 may be devoid of conductive scattering elements. In such embodiments, each second laminae 250 may simply comprise the dielectric substrate 252 such as a plastic plate. In embodiments where the second laminae 250 do not include any conductive scattering elements, it is axiomatic that the density of conductive scattering elements included in the second laminae 250 is less than the density of conductive scattering elements included in the first laminae 240 (since each first laminae 240 includes conductive scattering elements 244, while the second laminae 250 do not). In other embodiments, at least one of the second laminae 250 may comprise a dielectric substrate 252 that has at least one conductive scattering element (not shown) thereon. In such embodiments, the density of conductive scattering elements 244 on at least one of the first laminae 240 exceeds a density of conductive scattering elements (not shown) on at least one of the second laminae 250, and in some cases the density of conductive scattering elements on each of the first laminae 240 may exceed the density of conductive scattering elements (not shown) on at least one of the second laminae 250 and may exceed respective densities of conductive scattering elements (not shown) on all of the second laminae 250.

As shown in FIG. 20, in some embodiments, the number of first laminae 240 may exceed the number of second laminae 250. For example, the number of first laminae 240 may be at least twice, at least three times, at least four times or at least five times the number of second laminae 250. Moreover, a thickness of at least one of the second laminae 250 may exceed a thickness of at least one of the first laminae 240, and may exceed the thicknesses of all of the first laminae 240. The first and second laminae 240, 250 may define a cylinder.

The cylindrical RF lens 230 of base station antenna 200 only implements conductive scattering elements 244 on the radially-extending dielectric substrates 242 of the first laminae 240, and uses plain dielectric substrates 252 of the second laminae 250 (i.e., dielectric substrates that do not include conductive scattering elements thereon) as the focusing media in the horizontal planes. It has been found that this arrangement may greatly reduce coupling between adjacent linear arrays 220 of radiating elements 222. The number, thickness and/or dielectric constants of the second laminae 250 may be adjusted to achieve sufficient focusing in the horizontal plane. It has been found that a small number of second laminae 250 may be used, particularly if they are thickened and/or formed of high dielectric constant material. This may simplify construction of the cylindrical RF lens 230 and reduce the cost thereof. As shown, the second laminae 250 need not be symmetrically arranged. In the depicted embodiment, an extra dielectric second laminae 250 is provided near the top of the cylindrical RF lens 230. This may facilitate, for example, providing a downtilt to the generated antenna beams in the elevation plane.

Still referring to FIG. 20, pursuant to further embodiments of the present invention, base station antennas are provided that comprise a cylindrical RF lens 230 that comprises a set of first laminae 240, each first laminae 240 extending radially outward from an axis, and a radiating element 222 that is configured to radiate toward the cylindrical RF lens 230. Each first laminae 240 comprises a planar dielectric substrate 242 and a plurality of conductive scattering elements 244 on at least one major surface of the planar dielectric substrate 242. The cylindrical RF lens 230 may also comprise a set of second laminae 250, each second laminae 250 intersecting at least two of the first laminae 240. In some embodiments, each second laminae 250 extends in a respective plane that is parallel to planes defined by major surfaces of each first laminae 240.

In some embodiments, a first number of first laminae 240 in the set of first laminae 240 exceeds a second number of second laminae 250 in the set of second laminae 250. In some embodiments, a thickness of at least one of the second laminae 250 exceeds a thickness of at least one of the first laminae 240. In some embodiments, a thickness of at least one of the second laminae 250 exceeds thicknesses of every one of the first laminae 240.

In some embodiments, each second laminae 250 comprises a dielectric substrate 252 which optionally may have one or more conductive scattering elements on at least one major surface thereof, and wherein a density of conductive scattering elements on at least one of the first laminae 240 exceeds a density of conductive scattering elements on at least one of the second laminae 250. In some embodiments, respective densities of conductive scattering elements on each of the first laminae 240 exceed a density of conductive scattering elements on at least one of the second laminae 250.

In some embodiments, the cylindrical RF lens 230 further comprises a cylindrical support element 234 having a plurality of slots 236, wherein an edge of each first laminae 240 is received within a respective one of the slots 236 in the cylindrical support element.

Still referring to FIG. 20, pursuant to other embodiments of the present invention, base station antennas are provided that comprise a cylindrical RF lens that comprises a set of first laminae, each first laminae extending in a respective one of a plurality of vertical planes and a set of second laminae, each second laminae extending in a respective one of a plurality of horizontal planes; and a radiating element that is configured to radiate toward the RF lens. Each first laminae comprises a planar dielectric substrate and a plurality of conductive scattering elements on at least one major surface of the planar dielectric substrate.

In still other embodiments, base station antennas are provided that comprise a cylindrical RF lens 230 that has a central axis and a radiating element 222 that is configured to radiate toward the cylindrical RF lens 230. The cylindrical RF lens 230 comprises a set of first laminae 240, each first laminae 240 extending radially outward from the central axis and a set of second laminae 250, each second laminae 250 extending perpendicular to the central axis. A first number of first laminae 240 in the set of first laminae 240 exceeds a second number of second laminae 250 in the set of second laminae 250.

Still referring to FIG. 20, in yet other embodiments, base station antennas are provided that comprise a cylindrical RF lens 230 and a radiating element 222 that is configured to radiate toward the cylindrical RF lens 230. The cylindrical RF lens 230 comprises a set of first laminae 240, each first laminae 240 extending in a respective one of a plurality of vertical planes and a set of second laminae 250, each second laminae 250 extending in a respective one of a plurality of horizontal planes. Each first laminae 240 comprises a planar dielectric substrate 242 and a plurality of conductive scattering elements 244 on at least one major surface of the planar dielectric substrate 222, and each second laminae 250 comprises a dielectric substrate 252, and a density of conductive scattering elements 244 on at least one of the first laminae 240 exceeds a density of conductive scattering elements on at least one of the second laminae 250.

The electrical performance of antennas embodying the present invention is not constrained to the examples provided. At least the following parameters may be varied according to requirements for operating frequency, bandwidth, gain, beamwidth, sidelobe levels and cross-polar performance: the external diameter of a lens, the number and spacing of concentric arrangements of conductive scattering elements, the configuration of the conductive scattering elements and their mutual disposition, and the positioning and beamwidth of the radiating elements.

In some embodiments, for example if the RF lens is required to support a plurality of radiating elements oriented in differing radial directions, the concentric cylinders supporting conductive scattering elements is preferably a circular cylinder, but the use of an elliptical cylinder may be preferred for an RF lens designed to form a beam in a single radial direction.

In some embodiments the diameters of the concentric dielectric cylinders supporting the conductive scattering elements may increase in equal increments. In other embodiments the said increments may be unequal.

In some embodiments the conductive scattering elements may have the same configuration on each concentric dielectric cylindrical shell, while in other embodiments the configuration may differ between shells.

In some embodiments the spacing between conductive scattering elements may be the same on each concentric dielectric cylindrical shell, while in other embodiments the spacing may differ between shells.

It some embodiments, the dielectric shells with conductive scattering elements thereon and/or the first laminae of base station antenna 200 may be implemented using thin printed circuit laminate, for example FR4, by the use of standard printed circuit processes. A laminate thickness of 0.254 mm (10 mil) is found to be convenient.

In some embodiments the dielectric plates 13 may be of constant thickness, while in other embodiments the thickness of the dielectric plates may vary as a function of the distance from the longitudinal axis of the lens.

In some embodiments a plurality of dielectric plates 13 may be formed as a single entity, for example by injection molding, while in other embodiments it may be formed as an assembly of separate plates which may be supported by a central axial dielectric member.

In some embodiments radiating elements may be in the form of crossed dipoles with reflectors, while in other embodiments the radiating elements may be any other form of wide beam unidirectional element including but not limited to patches or horns.

The axial length of a cylindrical lens may be extended to provide for use in combination with an extended array of radiating elements.

It will be appreciated that many modifications may be made to the example base station antennas described above without departing from the scope of the present invention. For example, the operating frequency, bandwidth, gain, beamwidths, sidelobe levels, cross-polarization discrimination may all vary from the examples shown herein, as may external diameter of the RF lenses, the number and spacing of the laminae, the number and spacing of conductive scattering elements, the configuration of the scattering elements and their mutual disposition, and the positioning and beamwidths of the radiating elements.

As a few examples of changes that may be made, in some embodiments, the conductive scattering elements may have the same configuration on each laminae, while in other embodiments the configuration may differ between shells. In some embodiments the spacing between conductive scattering elements may be the same on each laminae, while in other embodiments the said spacing may differ between laminae. In some embodiments, the conductive scattering elements may be formed on FR4 substrates by implementing the laminae using printed circuit boards. A thickness of the dielectric substrate of 0.76 mm (30 mil) is found to be convenient.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Herein, a first element overlaps a second element in a given direction (e.g., the forward direction) if an axis that extends in the direction passes through both elements.

Herein, the term “substantially” refers to variation of less than 10%, unless otherwise noted.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1-10. (canceled)

11. A base station antenna comprising:
a radiating element; and
a cylindrical RF lens that comprises a plurality of concentric cylindrical dielectric shells, wherein each dielectric shell supports a plurality of conductive scattering elements, the conductive scattering elements being arranged in rows and columns, the rows and columns being aligned to extend at angles of 45° and −45° relative to an axis of the cylindrical RF lens.

12. The base station antenna of claim 11, wherein the cylindrical RF lens further comprises a plurality of dielectric plates, each dielectric plate extending in a respective radial direction and having a first edge proximate an axis of the cylindrical RF lens.

13. The base station antenna of claim 12, wherein the angles between the radial directions are equal.

14. The base station antenna of claim 12, wherein the cylindrical RF lens includes more dielectric plates than cylindrical dielectric shells.

15. The base station antenna of claim 12, wherein each of the dielectric plates includes a plurality of slots that extend parallel to the axis of the cylindrical RF lens.

16. (canceled)

17. The base station antenna of claim 12, wherein a dielectric constant of at least one of the dielectric plates exceeds a dielectric constant of at least one of the cylindrical dielectric shells.

18. The base station antenna of claim 17, wherein the dielectric plates are devoid of conductive scattering elements.

19. The base station antenna of claim 17, wherein a thickness of at least one of the dielectric plates exceeds a thickness of at least one of the cylindrical dielectric shells.

20-33. (canceled)

34. A base station antenna, comprising:
a cylindrical RF lens that comprises a set of first laminae, each first laminae extending radially outward from an axis; and
a radiating element that is configured to radiate toward the cylindrical RF lens,
wherein each first laminae comprises a planar dielectric substrate and a plurality of conductive scattering elements on at least one major surface of the planar dielectric substrate.

35. The base station antenna of claim 34, the cylindrical RF lens further comprising a set of second laminae, each second laminae intersecting at least two of the first laminae.

36. The base station antenna of claim 35, wherein each second laminae extends in a respective plane that is parallel to planes defined by major surfaces of each first laminae.

37. The base station antenna of claim 35, wherein a first number of first laminae in the set of first laminae exceeds a second number of second laminae in the set of second laminae.

38. The base station antenna of claim 35, wherein a thickness of at least one of the second laminae exceeds a thickness of at least one of the first laminae.

39-41. (canceled)

42. The base station antenna of claim 35, wherein each first laminae comprises a planar dielectric substrate and a plurality of conductive scattering elements on at least one major surface of the planar dielectric substrate, and at least one of the second laminae is devoid of conductive scattering elements.

43. (canceled)

44. The base station antenna of claim 34, the RF lens further comprising a cylindrical support element having a plurality of slots, wherein an edge of each first laminae is received within a respective one of the slots in the cylindrical support element.

45-49. (canceled)

50. A base station antenna, comprising:
a cylindrical RF lens that has a central axis, the cylindrical RF lens comprising:
a set of first laminae, each first laminae extending radially outward from the central axis;
a set of second laminae, each second laminae perpendicular to the central axis; and
a radiating element that is configured to radiate toward the cylindrical RF lens,
wherein a first number of first laminae in the set of first laminae exceeds a second number of second laminae in the set of second laminae.

51. The base station antenna of claim 50, wherein the first number is at least three times the second number.

52. The base station antenna of claim 50, wherein a thickness of at least one of the second laminae exceeds a thickness of at least one of the first laminae.

53. The base station antenna of claim 50, wherein each of the first laminae comprises a planar dielectric substrate and a plurality of conductive scattering elements on at least one major surface of the planar dielectric substrate.

54. The base station antenna of claim 53, wherein a density of conductive scattering elements on at least one of the first laminae exceeds a density of conductive scattering elements on at least one of the second laminae.

55-60. (canceled)
